(19) United States
(12) Patent Application Publication
(10) Pub. No.: US 2014/0148934 A1
(43) Pub. Date: May 29, 2014

(54) UNIFIED COMMUNICATIONS BRIDGING ARCHITECTURE

(71) Applicant: ClearOne Communication, Inc., Salt Lake City, UT (US)

(72) Inventors: Peter H. Manley, Draper, UT (US); Bret Harris, Orem, UT (US); Derek Graham, South Jordan, UT (US); Michael Tilelli, Syracuse, UT (US)

(73) Assignee: ClearOne Communication, Inc., Salt Lake City, UT (US)

(21) Appl. No.: 14/084,435

(22) Filed: Nov. 19, 2013

Related U.S. Application Data
(60) Provisional application No. 61/728,674, filed on Nov. 20, 2012.

(51) Int. Cl. G06F 17/30

(52) U.S. Cl. CPC G06F 17/3074
USPC 700/94

(57) ABSTRACT

A unified communications (UC) device may comprise a processor configured to enable audio communication between a plurality of different UC clients according to a UC bridging software architecture, the plurality of different UC clients having different communication formatting requirements. A computer readable medium may have instructions stored thereon, that when executed by a processor cause the processor to: translate a first client specific command for a first UC client to a second client specific command for a second UC client; and bridge audio from the first UC client and the second UC client. Another embodiment includes a related UC method. The method comprises bridging audio from a plurality of different UC clients having different communicating formatting requirements, and enabling commands to be communicated between the plurality of different UC clients by translating commands between the plurality of different UC clients.

### PRIORITY CLAIM

This application claims the benefit of the filing date of U.S. Provisional Patent Application Ser. No. 61/728,674, filed Nov. 20, 2012, for “UNIFIED COMMUNICATIONS BRIDGING ARCHITECTURE.”

### TECHNICAL FIELD

The present disclosure generally relates to unified communications. More particularly, embodiments of the present disclosure relate to a unified communications bridging architecture configured to enable communication between different types of unified communications clients.

### BACKGROUND

The enterprise communications market has seen an increase in unified communications (UC) software. UC is the concept of real-time business communication services being seamlessly integrated. For example, UC may include (but is not limited to) the following: telephony (including IP telephony), call control and multimodal communications, presence information, instant messaging (e.g., chat), unified messaging (e.g., integrated voicemail, e-mail, SMS and fax), speech access and personal assistant, video conferencing, collaboration tools (e.g., shared whiteboard, application sharing, etc.), mobility, business process integration (BPI) and a software solution to enable business process integration. UC is not a single product, but a set of products that provides a consistent unified user interface and user experience across multiple devices and media types. UC is an evolving communications technology architecture, which automates and unifies many forms of human and device communications in context, and with a common experience. Some examples of commonly used UC clients include Skype, Microsoft Lync, Mirial SoftClient, Cisco IP Communicator, etc.

The term of “presence” is also a factor—knowing where one's intended recipients are and if they are available, in real time—and is itself a notable component of UC. To put it simply, UC integrates the systems that a user might already be using and helps those systems work together in real time. For example, UC technology may enable a user to seamlessly collaborate with another person on a project, even if the two users are in separate locations. The user may quickly locate the desired person by accessing an interactive directory, engage in a text messaging session, and then escalate the session to a voice call, or even a video call—all within minutes. In another example, an employee receives a call from a customer who wants answers. UC may enable the employee to access a real-time list of available expert colleagues, and make a call that would reach the desired person, which may enable the employee to answer the customer faster while potentially eliminating rounds of back-and-forth e-mails and phone-tag.

The examples in the previous paragraph primarily describe “personal productivity” enhancements that tend to benefit the individual user. While such benefits may be valuable, enterprises are finding that they can achieve even greater impact by using UC capabilities to transform business processes. This is achieved by integrating UC functionality directly into the business applications using development tools provided by many of the suppliers. Instead of the individual user invoking the UC functionality to, for example, find an appropriate resource, the workflow or process application automatically identifies the resource at the point in the business activity where one is needed.

UC implementations present similar functionality and user experiences yet the underlying technologies are diverse, supporting multiple protocols that include: XMPP; SIMPLE for IM/P; H.323, SIP, XMPP/Jingle for Voice & Video. Additionally, there are disparate protocols for Data Conferencing Multiple Codec's used for voice and video: e.g., G.711/729, H.263/264, etc. Finally, there are many proprietary media stack implementations addressing IP packet loss, jitter and latency in different ways.

UC clients may be limited because there are no standards for telephony and UC client specific audio controls. As a result, each vendor may have a proprietary set of Application Programming Interfaces (APIs) specific to the soft client. For example, Skype uses a proprietary software API command structure, whereas Microsoft Lync uses a proprietary set of USB HID commands, and so on. The result is that hardware manufacturers must provide UC client specific firmware and/or software with their hardware devices to enable all of their features to work with a specific soft client. In addition, if an end user desires to create a multi-party call between users registered on different soft clients (e.g., between a user on Lync and another user on Skype), the different UC clients are non-compatible and unable to communicate or participate in the same UC system.

### SUMMARY

Embodiments of the present disclosure include a unified communications device, comprising a processor configured to enable audio communication between a plurality of different UC clients according to a UC bridging software architecture, the plurality of different UC clients having different communication formatting requirements.

Another embodiment of the present disclosure includes a computer readable medium having instructions stored thereon, that when executed by a processor cause the processor to: translate a first client specific command for a first unified communication client to a second client specific command for a second UC client; and bridge audio from the first UC client and the second UC client.

Yet another embodiment includes a method for unified communication. The method comprises bridging audio from a plurality of different UC clients having different communicating formatting requirements, and enabling commands to be communicated between the plurality of different UC clients by translating commands between the plurality of different UC clients.

### BRIEF DESCRIPTION OF THE SEVERAL VIEWS OF THE DRAWINGS

FIG. 1 is communication device configured for practicing embodiments of the present disclosure.

FIG. 2 illustrates a UC system according to an embodiment of the present disclosure.

FIG. 3 is a software block diagram of a UC bridging architecture according to an embodiment of the present disclosure.

FIG. 4 is a software block diagram of a UC bridging architecture for illustrating the flow of audio routing through the UC bridging architecture according to an embodiment of the present disclosure.

FIG. 5 is a software block diagram of a UC bridging architecture for illustrating the flow of command routing through the UC bridging architecture according to an embodiment of the present disclosure.

FIG. 6 is a software block diagram of a UC bridging architecture for illustrating the flow of command routing through the UC bridging architecture according to an embodiment of the present disclosure.

### DETAILED DESCRIPTION

In the following description, reference is made to the accompanying drawings in which is shown, by way of illustration, specific embodiments of the present disclosure. Other embodiments may be utilized and changes may be made without departing from the scope of the disclosure. The following detailed description is not to be taken in a limiting sense, and the scope of the present invention is defined only by the appended claims.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks and modules described in connection with the embodiments disclosed herein may be implemented or performed with a general-purpose processor, a special-purpose processor, a Digital Signal Processor (DSP), an Application-Specific Integrated Circuit (ASIC), a Field-Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

Also, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer readable media. Computer-readable media includes both computer storage media and communication media, including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. In addition, unless stated otherwise, a set of elements may comprise one or more elements.

Embodiments of the present disclosure include a UC bridging architecture that enables different UC soft clients to concurrently share common hardware and bridge audio streams between soft clients running on the common hardware. In particular, embodiments of the present disclosure may include a software architecture, wherein a virtual audio device driver interface routes audio streams to a mixer/router software interface, and wherein a command translator may translate UC client specific commands to device specific commands. While the software architecture may cause external software to be required in order to operate a UC device, the architecture may solve a problem of conventional systems, which require several different device firmware implementations to support different UC soft clients. As a result, an improved conferencing bridge between different UC soft clients may be created. In addition, by incorporating audio bridging/mixing/routing functionality, the software architecture described herein may allow audio bridging between software UC clients, thereby expanding the capability and flexibility of the UC platform and increasing the value of the audio peripherals attached to the system. Embodiments of the present disclosure may also create conferencing groups between different sets of UC clients.

Embodiments of the present disclosure may also include enabling audio to be routed to and from a plurality of audio devices, which may enable a reference audio stream to be sent to an echo cancelling audio recording device and an audio output device concurrently. Embodiments of the present disclosure may also map device controls to one or more connected audio devices, and synchronize device controls between one or more designated UC clients within a UC client group.

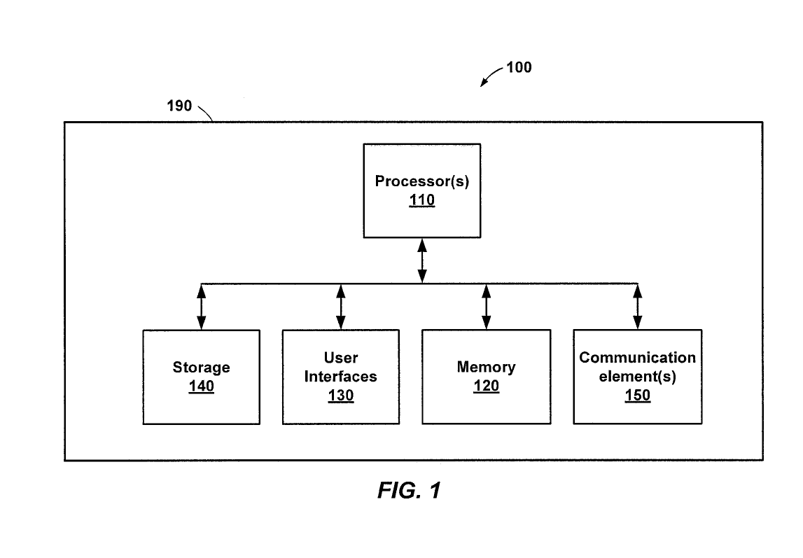

FIG. 1 is communication device 100 configured for practicing embodiments of the present disclosure. The communication device 100 may include elements for executing software applications as part of embodiments of the present disclosure. As non-limiting examples, the communication device 100 may be a conferencing apparatus, a user-type computer, a file server, a notebook computer, a tablet computer, a handheld device, a mobile device (e.g., smart phone), or other similar computer system for executing software.

The communication device 100 may include one or more processors 110, memory 120, user interface elements 130, storage 140, and one or more communication elements 150, each of which may be inter-coupled, such as over a communication bus. Each of the one or more processors 110, memory 120, user interface elements 130, storage 140, and one or more communication elements 150 may be included within the same housing 190.

The one or more processors 110 may be configured for executing a wide variety of applications including computing instructions for carrying out embodiments of the present disclosure. In other words, when executed, the computing instructions may cause the one or more processors 110 to perform methods described herein.

The memory 120 may be used to hold computing instructions, data, and other information while performing a wide variety of tasks including performing embodiments of the present disclosure. By way of example, and not limitation, the memory 120 may be configured as volatile memory and/or non-volatile memory, which may include Synchronous Random Access Memory (SRAM), Dynamic RAM (DRAM), Read-Only Memory (ROM), Flash memory, and the like.

The interface elements 130 may be configured to present information to a user and/or receive information from the user. As non-limiting examples, the user interface elements 130 may include input/output elements such as displays, keyboards, mice, joysticks, haptic devices, microphones, speakers, cameras, and touch screens. In some embodiments, the interface elements 130 may be configured to enable to interact with the communication device 100 through the use of graphical user interfaces.

The storage 140 may include one or more storage devices configured to store relatively large amounts of non-volatile information for use in the communication device 100. For example, the storage 140 may include computer-readable media, such as magnetic and optical storage devices (e.g., disk drives, magnetic tapes, compact discs (CDs), digital versatile discs or digital video discs (DVDs)), and other similar storage devices.

Software processes illustrated herein are intended to illustrate representative processes that may be performed by the systems illustrated herein. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in flow charts. Furthermore, the processes may be implemented in any suitable hardware, software, firmware, or combinations thereof.

When executed as firmware or software, the computing instructions for performing the processes may be stored on a computer-readable medium. By way of non-limiting example, computing instructions for performing the processes may be stored on the storage 140, transferred to the memory 120 for execution, and executed by the processors 110. The processor 110, when executing computing instructions configured for performing the processes, constitutes structure for performing the processes and can be considered a special-purpose computer when so configured. In addition, some or all portions of the processes may be performed by hardware specifically configured for carrying out the processes.

The communication elements 150 may be configure to communicate with other communication devices and/or communication networks. As non-limiting examples, the communication elements 150 may include elements configured to communicate on wired and/or wireless communication media, such as for example, serial ports, parallel ports, Ethernet connections, universal serial bus (USB) connections IEEE 1394 (“firewire”) connections, BLUETOOTH® wireless connections, 802.1 a/b/g/n type wireless connections, and other suitable communication interfaces and protocols.

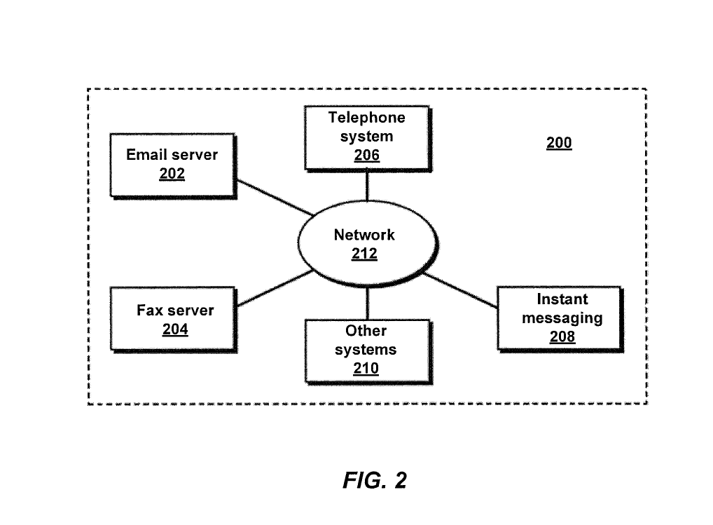

FIG. 2 illustrates a UC system 200 according to an embodiment of the present disclosure. The UC system 200 may include one or more of the following components: e-mail server 202, fax server 204, telephone system 206, instant messaging 208, and other systems 210, such as digital presence systems or systems that may in the be part of a unified communication system. Each of these components may communicate with each other over a network 212, such as a LAN or WAN (e.g., the Internet) environment. In some embodiments, the UC system 200 may be configured such that a plurality of the components reside on the same server or cluster of servers. In some embodiments, the UC system 200 may be configured such that a plurality of the components are located in the Internet “cloud.” Additional details regarding exemplary hardware devices, networks, or other similar components are described in U.S. patent application Ser. No. 13/494,779, filed Jun. 12, 2012, and entitled “Methods and Apparatuses for Unified Streaming Communication,” the entire disclosure of which is incorporated herein by this reference.

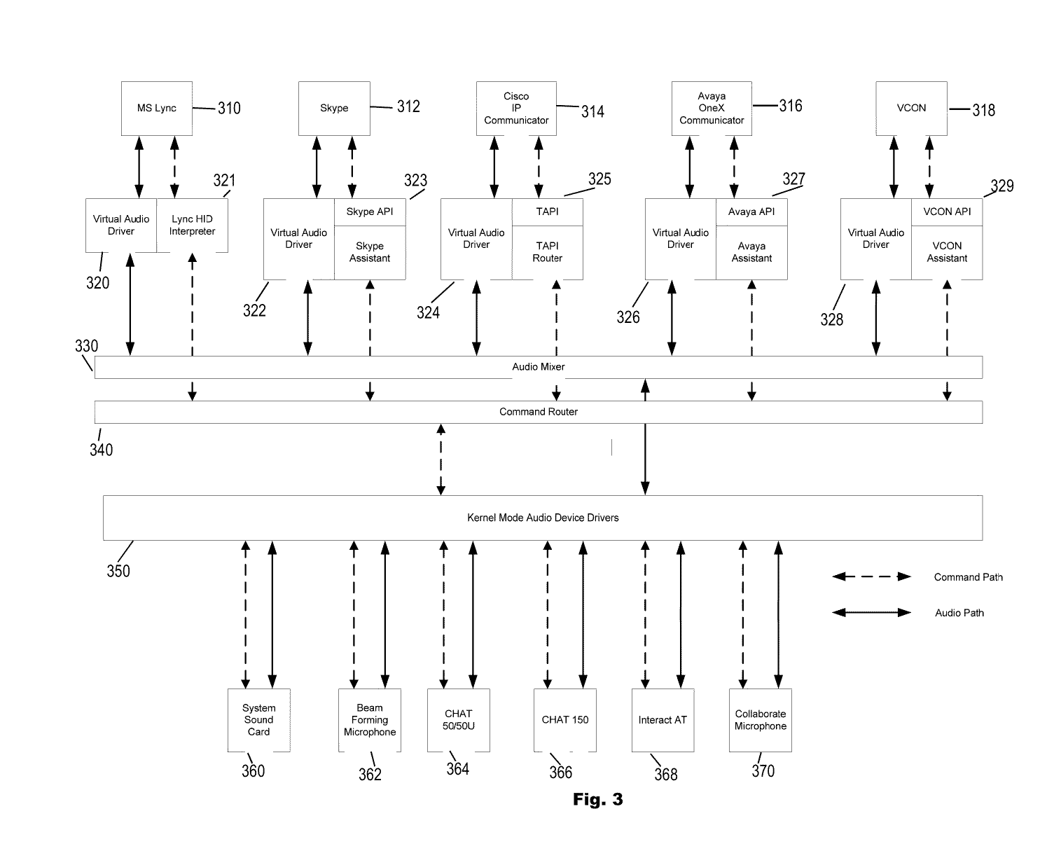

FIG. 3 is a software block diagram of a UC bridging architecture 300 according to an embodiment of the present disclosure. The UC bridging architecture 300 includes a plurality of UC clients 310-318 that may be connected to one or more audio devices 360-370. As shown in FIG. 3, examples of different UC clients include MS Lync, Skype, Cisco IP Communicator, Avaya OneX Communicator, and VCON. These UC clients are shown as examples, and other UC clients are contemplated, such as Google Talk, IBM Sametime, etc.

In conventional UC software architectures, the UC clients may be connected directly to the desired audio device. As a result, communication between different UC clients may not be permitted. In embodiments of the present disclosure, however, different UC clients 310-318 are coupled to an audio mixer 330 and a command router 340 that enable the different UC clients 310-318 to share common hardware and communicate with each other as well as different audio devices 360-370.

The audio devices 360-370 may include one or more audio input or output devices, such as sound cards, microphones, speakers, etc. As shown in FIG. 3, examples of different audio devices 360-370 include a system sound card, microphones (e.g., beam forming, collaborate, directional, omnidirectional, etc.), conferencing equipment (e.g., CHAT® devices, INTERACT® AT), mixing devices, headsets, etc. CHAT® devices and the INTERACT® AT are conferencing equipment available from ClearOne Communications, Inc. of Salt Lake City, Utah.

The UC clients 310-318 may connect to a virtual audio device driver (VADD) 320, 322, 324, 326, 328, respectively. The VADD 320, 322, 324, 326, 328 are configured to support a standard audio interface for receiving the audio signals from the UC clients 310-318. The VADD 320, 322, 324, 326, 328 may be kernel mode drivers that route audio to the audio mixer 330, which may be an application configured to perform audio mixing and routing to the connected audio devices 360-370 and other connected UC clients 310-318. The audio mixer 330 may also employ a mix-minus methodology for audio mixing.

The UC clients 310-318 may also connect to a command interpreter 321, 323, 325, 327, 329, respectively. The command interpreter 321, 323, 325, 327, 329 may be configured to support application specific command interpreter (e.g., application specific USB HID commands, or application specific API's). Each command interpreter 321, 323, 325, 327, 329 may be different depending on the associated UC client 310-318. For example, MS Lync may use an HID interpreter as the command interpreter 321. Skype may use a Skype API and Skype assistant as the command interpreter 323. Cisco IP communicator may use a TAPI and TAPI router as the command interpreter 325. Avaya OneX Communicator may use an Avaya API and Avaya assistant as the command interpreter 327. VCON may use a VCON API and VCON assistant as the command interpreter 329.

Control commands may be routed through the command router 340 in order to allow the connected audio devices 360-370 to control one or more of the connected UC clients 310-318. Examples of control commands include mute, volume up/down, on/off hook, dual tone multi-frequency (DTMF) digits, etc. Using this control architecture, telephony and audio controls may be fully synchronized between one or more physical audio devices and one or more UC clients 360-370.

In addition, the UC bridging architecture 300 may allow the user to select which UC client is predominantly used by the user. For example, the user of the device running the software for the UC bridging architecture may predominantly use Skype (although the users of other devices may use other UC clients). As a result, an application running on the device may use the call controls associated with that selected UC client as the basis for its command routing. Of course, commands to and from users having different UC clients may cause the commands to be translated as described herein.

In some embodiments, the UC clients 310-318 and the connected audio devices 360-370 may be grouped into separate conferencing groups, which may enable a group of specific UC clients (e.g., UC clients 310, 312, and 318) to be mapped to a group of audio devices (e.g., audio device 360 and 366). Of course, each group may include any combination of one or more UC clients 310-318 to be mapped to a group of audio devices 360-370. Such grouping may be useful when an echo cancelling microphone, requiring an echo cancelling reference must be designated as an active output device along with the actual output device, such as the system sound card.

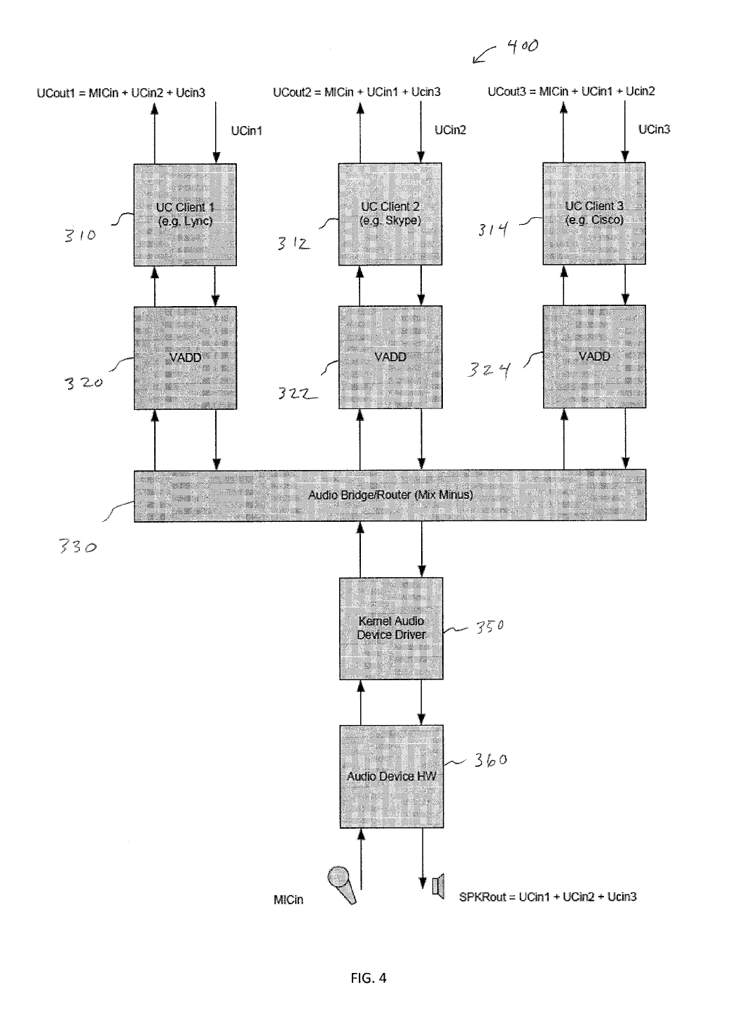

FIG. 4 is a software block diagram of a UC bridging architecture 400 for illustrating the flow of audio routing through the UC bridging architecture 400 according to an embodiment of the present disclosure. In contrast to conventional systems that may perform audio mixing and bridging at the hardware level (e.g., a centralized remote server acting as a conferencing bridge), embodiments of the present disclosure may perform audio mixing and bridging at the software level of a local conferencing device being operated by a participant of the UC session. In addition, as described above, conventional UC systems may not be configured to enable communication between different types of UC clients.

As shown in FIG. 4, the audio inputs (UCin1, UCin2, UCin3) may be received by the conferencing device running the UC bridging architecture. Each of the audio inputs may be associated with different UC clients (e.g., Lync, Skype, Cisco) and may be passed to its associated VADD 320, 322, 324 and then to the audio bridge/router 330 to mix the audio from each of the UC clients 310, 312, 314.

The device running the UC bridging architecture may also be connected to an external audio device 360 for the user to interact with. The external audio device may include a microphone and/or a speaker to input and/or output audio signals. The microphone input (MICin) may also be received by the device running the bridging architecture through the audio device driver 350 and passed to the audio bridge/router 330.

The audio bridge/router 330 may also route the mixed audio to be output as appropriate. The audio bridge/router 330 may be configured to mix the audio signals according to a mix minus methodology. As a result, each of the devices of a UC session may output the input signals from the other devices, but not its own input signal. In other words, the output to the first UC client 310 may be UCout1=MICin+UCin2+UCin3. Likewise, the outputs to the second UC client 312, the third UC client 314, and the audio device 360 may be UCout2=MICin+UCin1+UCin3, UCout3=MICin+UCin1+UCin2, and SPKRout=UCin1+UCin2+UCin3, respectively.

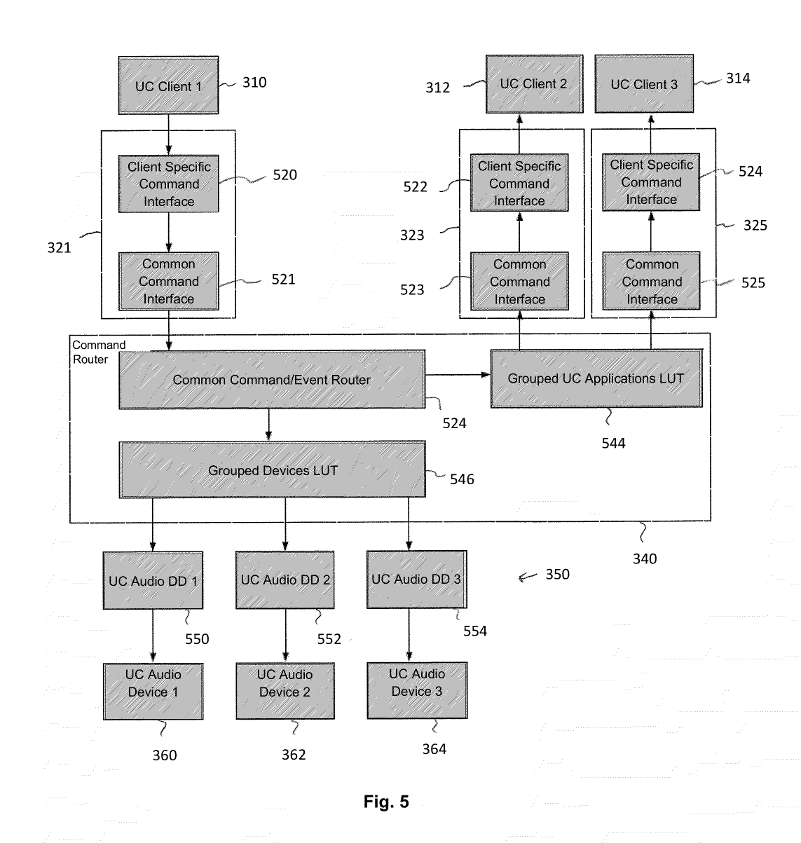

FIG. 5 is a software block diagram of a UC bridging architecture 400 for illustrating the flow of command routing through the UC bridging architecture 400 according to an embodiment of the present disclosure. In particular, FIG. 5 shows the flow of commands that are generated by the UC client 310-314. For example, FIG. 5 shows that a command is generated by the first UC client 310. Thus, the command is formatted by the UC client 310 as a client specific command.

The client specific command from the first UC client 310 may be received by the command interpreter 321 associated therewith. The command interpreter 321 may include a client specific command interface 520 and a common command interface 521 that are configured to translate the client specific command to a common command that is client agnostic (i.e., not specific to any particular UC client). The common command may be passed to the command router 340 for determination as to the destinations for the common command to be sent.

The command router 340 may include a common command event router 542 that passes the common commands to other UC clients 312, 314 for other participants in the UC session, to audio devices 360, 362, 364 connected to the user's device, or combinations thereof. In some embodiments, each common command may be sent to each of the UC clients 312-318 (some shown in FIG. 3) and each of the audio devices 360-370 (some shown in FIG. 3). In some embodiments, the common command may be sent to a subset of the UC clients and audio devices as a conferencing group. For example, a conferencing group may include a Skype client and a Lync client to be grouped together in a first group, and a Cisco client grouped together with an Avaya client in a second group. In addition, the Skype/Lync client group may be associated with a headset (audio device) of the user, while the Cisco/Avaya client group may be associated with a different conferencing device of the user. As a result, different collaboration groups may be created for a single device sharing multiple clients. Of course, other groupings and combinations are contemplated. The groupings may be determined according to a grouping object, or other appropriate methodology for associating UC applications and devices. For example, grouping objects may include a grouped UC applications look up table (LUT) 544 and a grouped devices LUT 546. For example, the command router 340 may examine the grouped devices LUT 546 to determine which audio devices 360, 362, 364 the user has defined that a particular command should be passed to. The command router 340 may also examine the grouped UC applications LUT 544 to determine which UC clients 312, 314 the user has defined that a particular command should be passed to. In some embodiments, not all commands are to the grouped UC clients and/or audio devices. For example, it may be determined that only certain commands (e.g., mute) are passed on, such as those that may be used to maintain synchronization between the various devices.

As shown in FIG. 5, the common commands are sent to the audio devices 360, 362, 364 through individual audio device drivers 550, 552, 554. The common commands may also be sent to the UC clients 312, 314. Because these UC clients 312, 314 are different types of UC clients, they are not expecting commands in the format of the common command Thus, the common commands may be translated from the common command format to a client specific command for the second UC client 312 through the common command interface 523 and the client specific command interface 522. Likewise, the common commands may be translated from the common command format to a client specific command for the third UC client 314 through the common command interface 525 and the client specific command interface 524.

As a result, a user may have a single device that can be used to talk to any other UC device regardless of the type of UC client. Having an abstraction layer within software between the UC clients 310, 312, 314 and the audio devices 360, 362, 364 enables the UC device running the software for the UC bridging architecture to translate between client specific commands and common commands so that the different UC clients 310-314 may talk with each other.

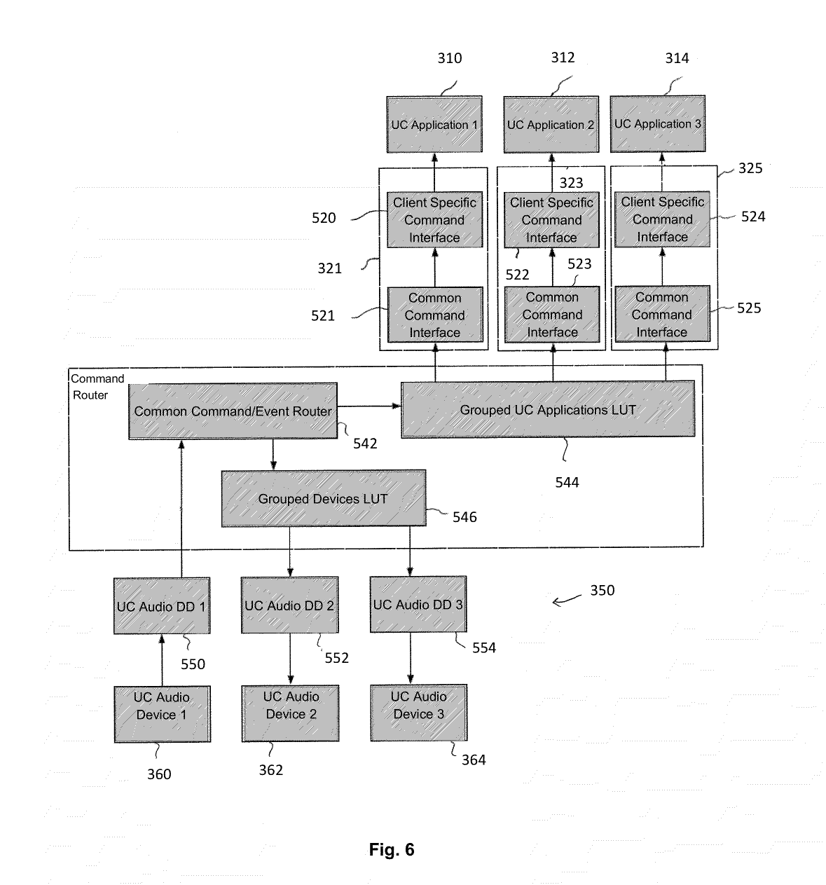

FIG. 6 is a software block diagram of a UC bridging architecture 400 for illustrating the flow of command routing through the UC bridging architecture 400 according to an embodiment of the present disclosure. In particular, FIG. 6 shows the flow of commands that are generated by the audio devices 360-370. For example, FIG. 6 shows that a command is generated by the first audio device 360. In some embodiments, the command may be formatted as a common command that is passed through the command router 340 to the other audio devices 362, 364 and the UC clients 310, 312, 314 as discussed above. In some embodiments, the command may be formatted as a client specific command according to the default settings chosen by the user as the desired setting. In these embodiments, if the command is not in the proper format for the desired destination, then the appropriate command interpreter 321, 323, 325 may be used to translate the incoming command to the proper format for the destination.

Although the foregoing description contains many specifics, these are not to be construed as limiting the scope of the present disclosure, but merely as providing certain exemplary embodiments. Similarly, other embodiments of the disclosure may be devised which do not depart from the scope of the present disclosure. For example, features described herein with reference to one embodiment also may be provided in others of the embodiments described herein. The scope of the invention is, therefore, defined only by the appended claims and their legal equivalents, rather than by the foregoing description.

What is claimed is:

1. A unified communications (UC) device, comprising:
a processor configured to enable audio communication between a plurality of different UC clients according to a UC bridging software architecture, the plurality of different UC clients having different communication formatting requirements.

2. The unified communications device of claim 1, wherein the UC bridging software architecture includes an audio bridge/router configured to mix audio received from a plurality of different virtual audio device drivers associated with the plurality of different UC clients.

3. The unified communications device of claim 2, wherein the audio bridge/router is configured to mix audio according to a mix minus methodology.

4. The unified communications device of claim 2, further comprising at least one audio device operably coupled with the processor, wherein the at least one audio device is configured to communicate audio with the audio bridge/router and a user of the unified communications device.

5. The unified communications device of claim 4, wherein the at least one audio device is selected from the group consisting of a sound card, a microphone, a speaker, conferencing equipment, a mixing device, and a headset.

6. The unified communications device of claim 1, wherein the UC bridging software architecture includes a command interpreter configured to translate commands from the communication formatting requirements of at least one of the UC clients to the communication formatting requirements of at least another of the UC clients.

7. The unified communications device of claim 6, wherein the command interpreter is further configured to translate commands from a client specific command to a common command.

8. The unified communications device of claim 6, wherein the UC bridging software architecture includes a command router configured to route the common commands between the plurality of UC clients and a plurality of audio devices.

9. The unified communications device of claim 6, wherein the command router is further configured to route the common commands between the plurality of UC clients and a plurality of audio devices according to a subset of user-defined groups.

10. The unified communications device of claim 9, wherein the command router includes a grouped devices look up table and a grouped UC client look up table configured to store instructions for the user-defined groups.

11. The unified communications device of claim 1, wherein the processor is configured to support a plurality of UC applications selected from the group consisting of telephony, call control and multimodal communications, presence information, instant messaging, unified messaging, speech access and personal assistant, video conferencing, collaboration tools, mobility, business process integration, and a software solution to enable business process integration.

12. A computer readable medium having instructions stored thereon, that when executed by a processor cause the processor to:
translate a first client specific command for a first unified communication (UC) client to a second client specific command for a second UC client; and
bridge audio from the first UC client and the second UC client.

13. The computer readable medium of claim 12, wherein the instructions further cause the processor to bridge audio from at least one audio device coupled with the processor for at least one of inputting audio from and outputting audio to a user.

14. The computer readable medium of claim 13, wherein the instructions further cause the processor to group a plurality of audio devices and a subset of the plurality of UC clients.

15. A method for unified communication (UC), the method comprising:
bridging audio from a plurality of different UC clients having different communicating formatting requirements; and
enabling commands to be communicated between the plurality of different UC clients by translating commands between the plurality of different UC clients.

16. The method of claim 15, wherein translating the commands between the plurality of different UC clients includes translating the commands from a first UC client specific command to a common command, and from the common command to a second UC client specific command.

17. The method of claim 15, further comprising bridging audio from at least one user audio device with the audio from the plurality of different UC clients.

18. The method of claim 15, further comprising grouping subsets of the plurality of different UC clients together with a plurality of user audio devices for sending commands thereto.

19. The method of claim 15, wherein enabling commands includes enabling commands selected from the group consisting of mute, volume up/down, on/off hook, and dual tone multi-frequency (DTMF) digits.

20. The method of claim 15, wherein bridging includes employing a mix minus methodology for mixing the audio.
